(19) United States
(12) Patent Application Publication
(10) Pub. No.: US 2012/0174797 A1
(43) Pub. Date: Jul. 12, 2012

(54) Applied Disposition in Pressure Cooker

(76) Inventor: Antonio Froza, Marmeleiro (BR)

(21) Appl. No.: 13/496,294

(22) PCT Filed: Sep. 16, 2010
(86) PCT No.: PCT/BR2010/000329

§ 371 Date: Mar. 15, 2012

(30) Foreign Application Priority Data
Sep. 17, 2009 (BR) PI0903794-2

(51) Int. Cl. A47J 27/08

(52) U.S. Cl. 99/325; 99/341; 99/348

(57) ABSTRACT

The present invention is about an innovative configuration applied in a pressure cooker, consisting of the application of visors coupled in the cover or in the body of the pan through the fencing, the installation of the lamp feed by batteries packed in the compartment in the interior's handle, the lamp connected by a button or key, or interrupter, installed in the same way in the handle's cover. The pan still can provide a chronometer or timer coupled in the same handle, and a crank made of shovels being bound on the cover for the movement during the cooking food. The equipment, described with its characteristics operation and checking, transforms what is already fast (cooking process with high pressure) into an economic process.

The present report of invention is about an innovative configuration applied in pressure cooker, belonging to the technologic sector of domestic and commercial tools, with characteristics that results in a mayor practice and efficiency in the process of cooking food.

In the technical sector, are known a lot of models and formats of pressure cooker with external and internal closure. Today it is verified that the pressure cookers are completely closured, blocking the vision of its interior. Different from the closed pressure cooker, it was developed a pressure cooker with a cover of glass (MU8800241-1) of the same inventor which cover is totally or partially made of galls in both closures. In the case of the closed pressure cooker, it is necessary to verify the conditions of the food, if it is necessary off the heat, put under cold water (water in the room temperature), so the temperature of the pressure cooker reduce and the internal pressure equals to the natural pressure, allowing the pressure cooker to be opened without risks.

The user verifies the condition of the food and if it is necessary, continues with the cook process through a new heating of the pressure cooker for the restoration of the internal pressure, wasting a great quantity of gas.

With these difficulties and wastes in the domestic and commercial everyday, the defined proposal presents an applied disposition in the pressure cooker totally new, showing tools that will produce economy, speed and practicality to the users, surpassing the models used nowadays.

In order to the object of this report be completely understood, without examples non limitative, the object will be described clearly, with examples referred in the drawings listed below:

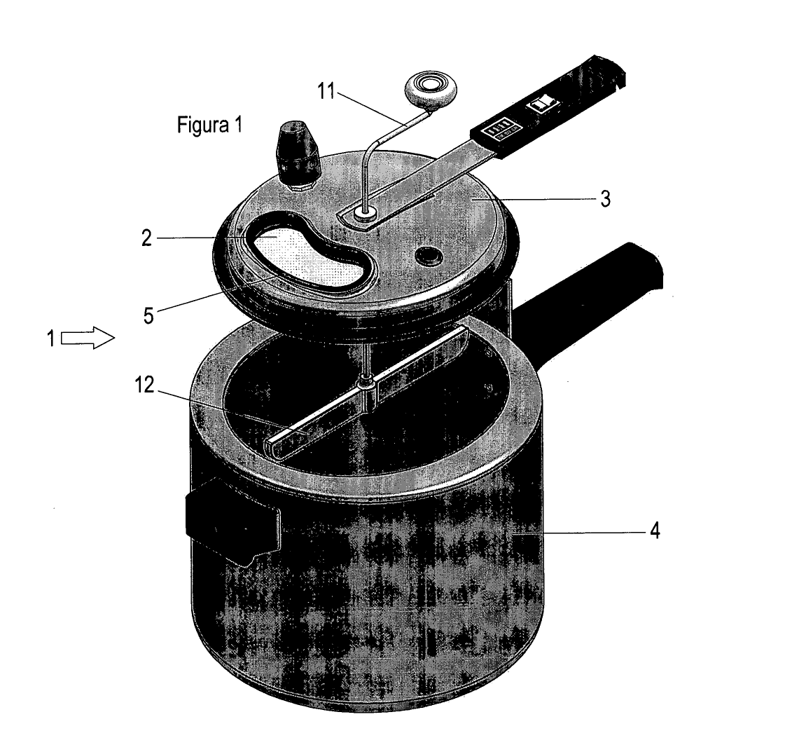

FIG. 1: An isometric view of the new disposition applied in the pressure cooker, pointing its internal and external tools.

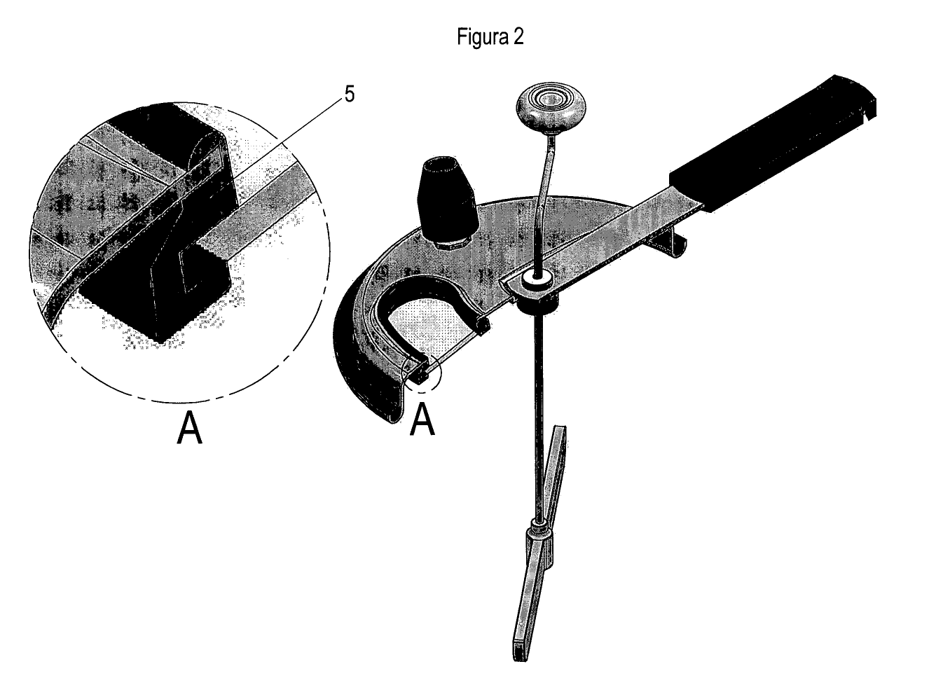

FIG. 2: An isometric view in a cut, showing the unions belonging to the seal responsible to the transparent cover.

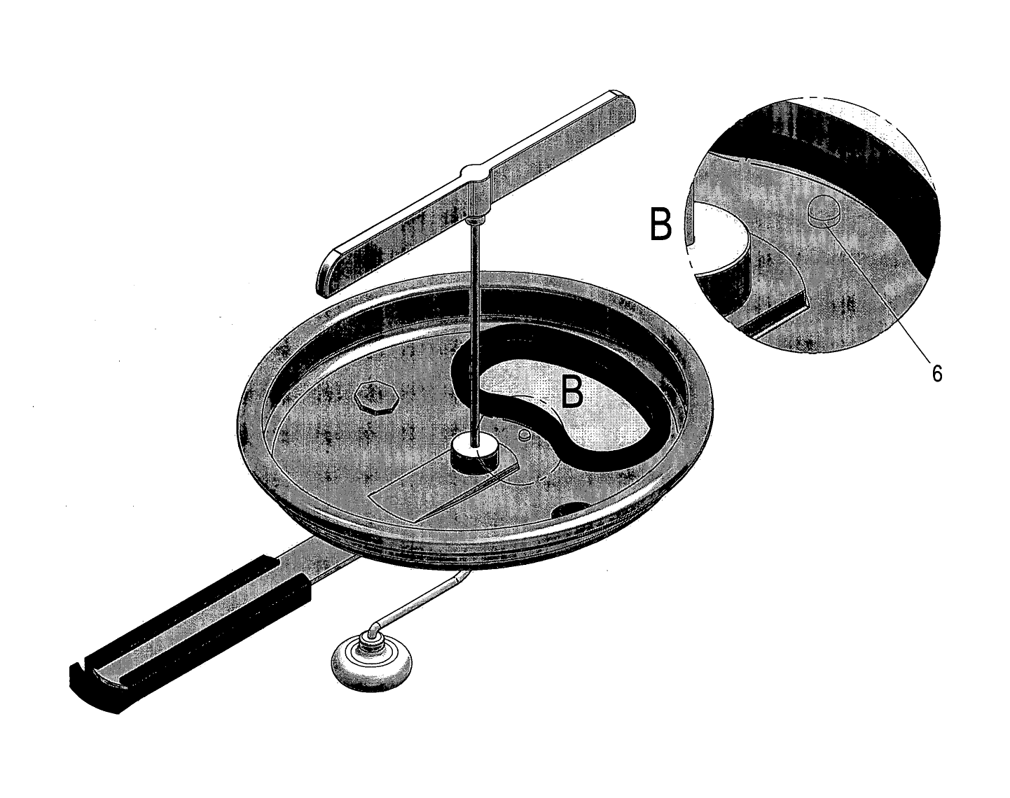

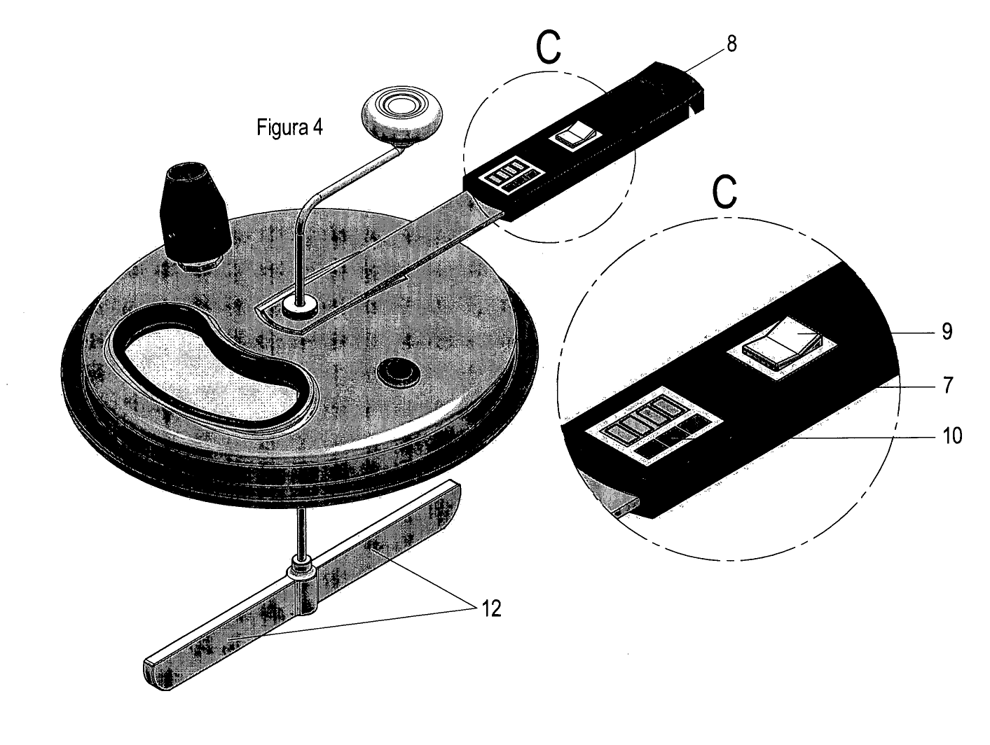

FIGS. 3 and 4: With isometrics views of the cover pointing the lamp near the cover, chronometer, the button or key or switch responsible to open the electric circuit and the place for the batteries that feed the lamp and the chronometer simultaneously.

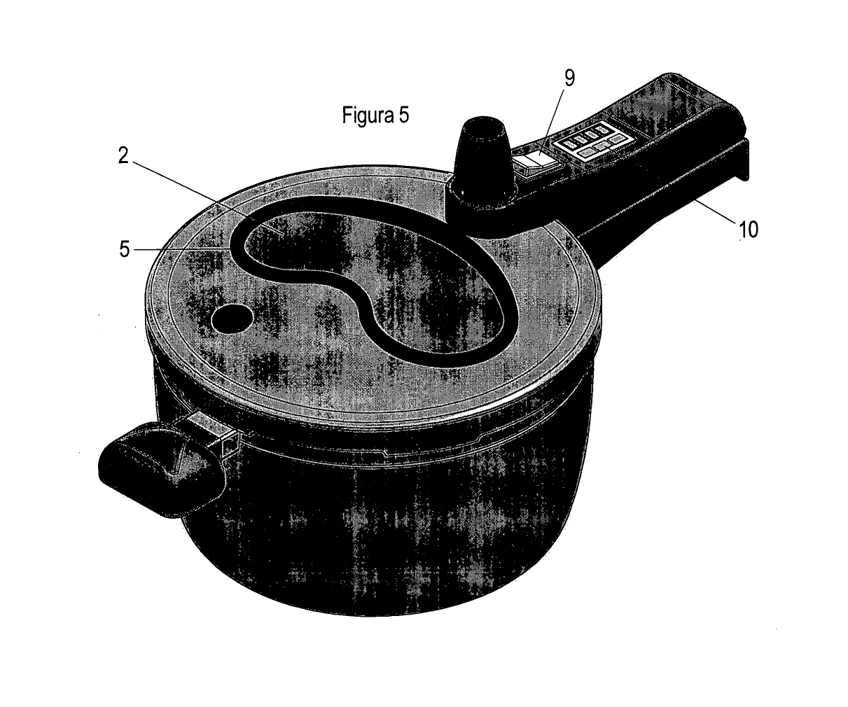

FIG. 5: Isometric view pointing the new tools including in the same way the pans with external closure.

The next technology proposes the developing of a pressure cooker with high resistance. For this effect, the body's pan can be made with cast iron and the cover with aluminum or stainless steel or another cast iron, receiving of the glass tool or another transparent material for the visualization in the cook process, lamp (in preference in a diode that emits lights, known as LED) in the interior or under the cover to light the internal region helping the visualization of the food, chronometer for the time regulation, a sound alarm to warn the user when the food is cooked and an handle to move the food during the process of cooking.

The project consists in the pressure cooker (1) composed by one or more visors (2) joined in the internal side of the cover (3) or in the body (4) of the pan, allowing the visualization of the food in the process of cooking without opening the cover, which will lose the pressure of the pan. Blocks of bodies of transparent material make these visors, with preference in tempered glass with a proper width and circular format, blocking the tension accumulation in its boards that can tear by mechanical stress. The fixation of the transparent visor or visors in the pan is possible by the blocking (5) with rubber, silicon or another similar material, developed with joins that allow the perfect link of the visor in the pan without lose its resistance in high temperatures and pressures.

Increasing the visualization of the food in cooking process, the technology possibilities the installation of a lamp (6) (preferentially a LED) intern or externally. There are a lot of points that can place this light. One case mentions the light transmission through the direct link of the lamp over the external face of the. Another way consists in join a lamp in a hole next to the visor of the cover or body's pan, remaining only the bulb facing the internal side. Batteries or similar will make the supply for the light, that will remain in the compartment (7) optionally in the interior's handle (8) that will provide an internal volume for that purpose, protected from the heat and water when cleaning and connected to the lamp with a button or interrupter (9) optionally installed in the handle's cover, closing or opening the passage of electric circuit.

Another feature of the pan consists in the usage of a chronometer (10) that allows the regulation of the time used for cooking in manual or automatic time count process at the moment the pan reaches the operating pressure. Its disposition offers a digital display operated by buttons controlled by the user, a digital display that operates just with maximum pressure or a regressive mechanic chronometer with a pendulum, sprockets and rotational movements blocked.

For the first case, through the buttons the user selects manually the activation of the chronometer, stop and zeroing. In the second case, the pressure relief valve, through the electric contact, active automatically the chronometer. As the pressure is the not at the maximum level, the chronometer stops the count and turn into zero when the pressure is at the atmospheric level. In the last case, o chronometer system is similar to a clock. Turning the body's chronometer under its base, it is automatically winding the watch. Doing this movement, is active the flexion of a trendy flat profile that wraps on a shaft connected to a shaft attached to a stop, blocking its process.

The energy source of the chronometer may be the same used by the lamp and the position, independent of the chronometer chosen, will be preferentially at the body's handle (8) belonging to the lamp's pan (3). Another detail of the chronometer assigns its regulation for the cooking time needed to the different types of food that, when reaches the time programmed by the internal pressure, releases an audible warning to remove the pan from the heat. Then, tests will be realized establishing a relation between the type, amount and cooking time for each food.

Ultimately, the pan has a crank (11) made of shovels (12) or totally made by wire coupled to the cover (3), objecting mix the food during the cook and establishing its application in preparation of other foods that requires movement during the cooking process, which until now were made with another utensils, admitting a option for the time reduction used in the process.

The impact of the product in the market represents economy of time in the cooking process, reduction in the gas consumption, more security to the user and consequently reduction of the polluters.

The equipment, described with its characteristics operation and checking, transforms what is already fast (cooking process with high pressure) into an economic process. The impact in the commercial area will be relevant, because the gas cost determines the cost of food preparation, transferring the final cost to the benefited food, what will attract the client to its consumption.

In summary, it is import to remember that the purpose presented in this report aims not to restrict the invention aims not to restrict the invention, allowing its usage in different genres, so that its understanding provides an enlightening description without limitation.

1. APPLIED DISPOSITION IN PRESSURE COOKER, using components made by transparent materials. in the pressure cooker (1), preferentially tempered glass with proper width and circular shape aiming prevent the buildup of tension on the edges, allowing the visualization of the food during the cooking process in its interior without opening the cover, what will depressurize the pan, wherein, one or more visors (2) coupled preferentially in the internal side of the cover (3) or body's (4) pan through the fencing (5).

2. APPLIED DISPOSITION IN PRESSURE COOKER, consisting in components that help the visualization of the food during the cooking process and regulation of the cooking time in manual or automatic count time process at the moment which the pan reach the right pressure, wherein the installation of a lamp (6) adapted over the external face of the visor(s) or coupled in a hole near the visor(s) of the cover or body with button or interrupter activation (9) and adaptation of a digital or mechanic chronometer (10), the lamp and the chronometer connected with batteries packed in the compartment (7), the button or key or interrupter (9}, the chronometer or timer (10) and the compartment (7} preferentially connected to the handle's (8} cover (3).

3. APPLIED DISPOSITION IN PRESSURE COOKER, concerns about a tool that objective mix the food during the cooking process and expand the application's pan to the preparation of another food that require movement during the cooking process, wherein the application of a crank (11) made of shovels (12} or totally made by wire coupled to the cover (3}.

4. APPLIED DISPOSITION IN PRESSURE COOKER according to claim 3, using material that provide high resistance to the body and cover's pan, wherein both of them made optionally by cast iron.
